(19) United States
(12) Patent Application Publication
(10) Pub. No.: US 2008/0080877 A1
(43) Pub. Date: Apr. 3, 2008

(54) Color image forming apparatus

(75) Inventor: Yoshinori Maruyama, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/882,849

(22) Filed: Aug. 6, 2007

(30) Foreign Application Priority Data
Sep. 29, 2006 (JP) 2006-268027

(51) Int. Cl. G03G 15/08

(52) U.S. Cl. 399/27

(57) ABSTRACT

The present invention aims at performing, in a color image forming apparatus, image adjustment processes with adequate amounts of toners remaining in the developers. The color image forming apparatus of the present invention comprises: an image adjuster operable to perform an image adjustment process under a predetermined condition; and a supply controller operable to make a judgment, with respect to each developer prior to the image adjustment process, on need for toner supply based on the quantity of the toner detected by a toner quantity detector, and to cause a supplier to perform the toner supply if the judgment is affirmative.

### BACKGROUND OF THE INVENTION

This application is based application No 2006-268027 filed in Japan, the content of which is hereby incorporated by reference.

### FIELD OF THE INVENTION

The present invention relates to a color image forming apparatus.

### RELATED ART

In conventional color image forming apparatuses, the remaining quantity of toner in the developer is monitored when the developer is being driven—i.e. when a printing job is in process, and toner is supplied when it is judged necessary.

Image forming apparatuses, such as printers, are prone to cause change in image density due to change in the temperature and humidity in the apparatuses and/or deterioration of the photosensitive drum or other parts.

Therefore, when predetermined conditions (e.g. for each printing job with a certain number of printout sheets) are satisfied, image adjustment (image stabilization) is performed in which control variables for each unit of the apparatus are changed to thereby maintain the quality of the printed images at a certain level.

In the case of, for example, successively performing printing in monochrome, only the black developer being driven is a target for monitoring the remaining quantity of toner, as described above.

Although, as to the other color developers being not driven, their remaining toner quantities are not monitored and toner supplies are not provided, the color toners of these color developers are also used in the image adjustment process, which leads to a progressive decrease in color toners.

Accordingly, there is a possibility that the image adjustment process is performed with inappropriate quantities of toners in the color developers and then inappropriate control variables are created.

If color printing is subsequently performed, the printing is based on the inappropriate control variables, which may result in poor quality of printed images.

### SUMMARY OF THE INVENTION

The present invention has been made in view of the problem, and aims at offering a color image forming apparatus capable of maintaining an appropriate quantity of toner in each developer in the image adjustment process.

In order to realize the above object, the present invention is a color image forming apparatus comprising: a plurality of developers; a plurality of toner bottles, each of which contains a toner of a color corresponding to a different one of the developers; a toner quantity detector operable to detect, with respect to each of the developers, quantity of a toner therein; a supplier operable to perform toner supply in which the toner in one of the toner bottles is supplied to a corresponding one of the developers; an image adjuster operable to perform an image adjustment process under a predetermined condition; and a supply controller operable to make a judgment, with respect to each of the developers prior to the image adjustment process, on need for the toner supply based on the quantity of the toner detected by the toner quantity detector, and to cause the supplier to perform the toner supply if the judgment is affirmative.

This structure prevents an image adjustment process from being carried out when the remaining toner quantity in each developer is low. Accordingly, an appropriate adjustment process is carried out, which enhances the quality of printed images obtained after the process.

Additionally, one of the developers may be for a black toner. Here, the color image forming apparatus further comprises: a developer controller operable to drive only the developer for the black toner in a case of forming a monochrome image.

According to the structure, even if printing in monochrome, for example, is successively performed, the image adjustment process can be carried out after toners of the developers, except for black, are supplied.

In addition, the toner quantity detector may detect the quantity of the toner only when the developer is being driven

In addition, the color image forming apparatus may further comprise: a storage operable to store therein toner quantity information for each of the developers, the toner quantity information including the developer and the detected quantity of the toner in the developer. Here, the supply controller makes the judgment based on the toner quantity information.

### BRIEF DESCRIPTION OF THE DRAWINGS

These and other objects, advantageous effects and features of the invention will become apparent from the following description thereof taken in conjunction with the accompanying drawings which illustrate specific embodiments of the invention. In the drawings:

FIG. 1 shows a structure of an MFP 1 according to an embodiment;

FIG. 2 is a functional block diagram showing a controller 140;

FIG. 3 is a cross-sectional diagram showing a structure of a developer 103Y;

FIG. 4 schematically shows a buffer 303 of the developer 103Y;

FIG. 5 is a waveform chart showing an example of the result of sensor outputs of an optical receiver;

FIG. 6 is a flowchart showing an image adjustment control process performed by the controller 140; and

FIG. 7 is a flowchart showing a toner supply process during a printing job performed by the controller 140.

### DESCRIPTION OF PREFERRED EMBODIMENTS

The following describes an embodiment of the image forming apparatus of the present invention with reference to drawings, taking an MFP 1 (Multi Function Peripheral) as an example.

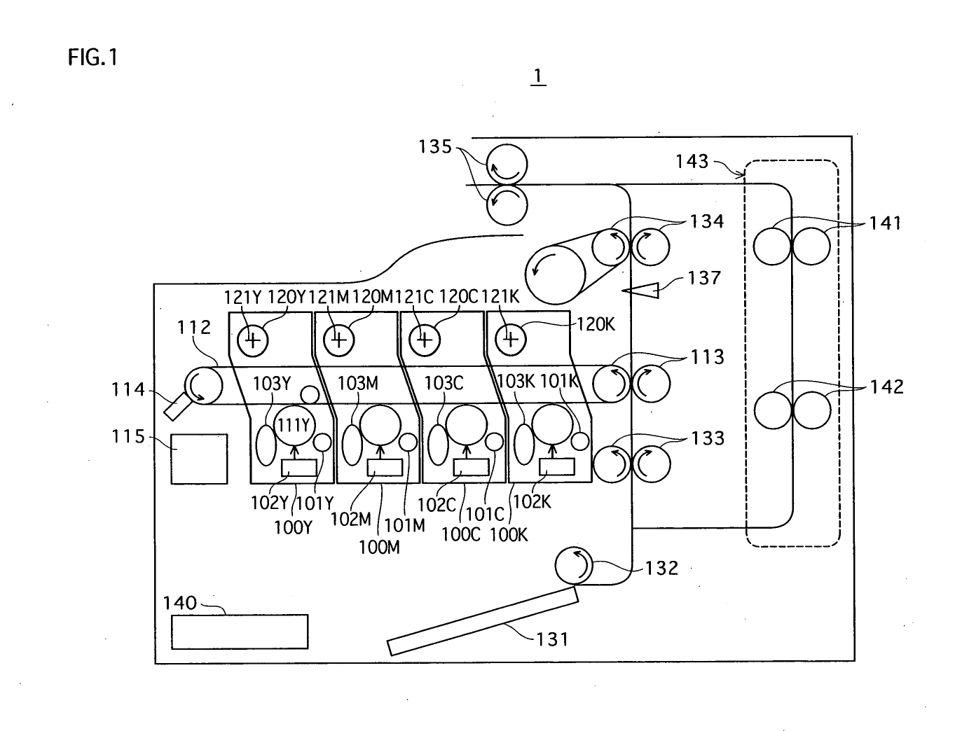

FIG. 1 shows a structure of the MFP 1 according to an embodiment.

As shown in FIG. 1, the MFP 1 includes: image forming units 100Y, 100M, 100C and 100K for yellow (Y), cyan (C), magenta (M) and black (K), respectively; an intermediate transfer belt 112; a secondary transfer roller 113; an intermediate transfer belt cleaner 114; a waste toner bottle 115; a toner bottles 120Y, 120M, 120C and 120K; a paper storage 131; a paper feed roller 132; a timing roller 133; a fixing roller 134; an eject roller 135; a loop sensor 137 that detects surface waviness on paper; a controller 140; and an automatic reversing unit 143.

The image forming unit 100Y includes: a charging unit 101Y; an exposing unit 102Y; a developing unit 103Y; and a photosensitive drum 111Y. The charging unit 101Y charges the photosensitive drum 111Y. The exposing unit 102Y exposes the photosensitive drum 111Y to form an electrostatic latent image. The developing unit 103Y develops the electrostatic latent image formed on the photosensitive drum 111Y.

The image forming units 100M, 100C and 100K have the same structure as the image forming unit 100Y.

On the intermediate transfer belt 112, images of four toners each formed on the photosensitive drums 111Y, 111M, 111C and 111K are subsequently overlaid to thereby form a multi-color toner image.

The secondary transfer roller 113 transfers the toner image formed on the intermediate transfer belt 112 to paper. The intermediate transfer belt cleaner 114 separates toner particles that were not transferred and remained from the intermediate transfer belt 112. The waste toner bottle 115 collects the separated toner particles.

The toner bottles 120Y, 120M, 120C and 120K have agitating blades 121Y, 121M, 121C and 121K, respectively, and supply a toner to corresponding image forming units 100Y, 100M, 100C and 100K.

The paper storage 131 stores therein paper. The paper feed roller 132 feeds paper stored in the paper storage 131.

The timing roller 133 determines the timing of sending out paper brought thereto, to the secondary transfer roller 113.

The fixing roller 134 fixes the toner image transferred to paper. The paper with the fixed toner image is ejected by the eject roller 135.

The controller 140 controls operations of the MFP 1.

The automatic reversing unit 143 includes transport rollers 141 and 142, and is used in two-sided printing.

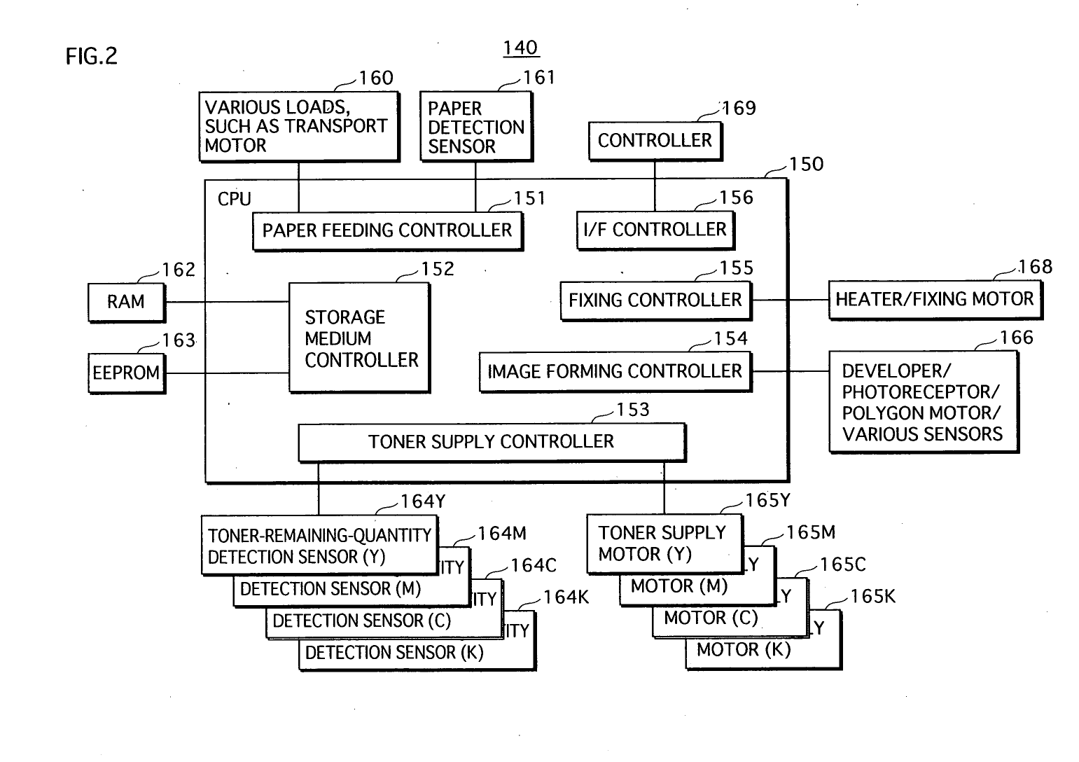

FIG. 2 is a functional block diagram showing the controller 140 of the MFP 1.

The CPU 150 includes: paper feeding controller 151; a storage medium controller 152; a toner supply controller 153; an image forming controller 154; a fixing controller 155; and an I/F controller 156.

The paper feeding controller 151 controls various loads 160, such as a transport motor, and paper detection sensor 161 that detects a paper position.

The storage medium controller 152 controls data input and output of a RAM 162 and an EEPROM 163. The RAM 162 and EEPROM 163 store therein data measured by the CPU and information of consumable goods, such as the remaining quantities of toners.

Note that, other than an EEPROM, consumable goods with an IC chip can be used to store information of these consumable goods.

The toner supply controller 153 carries out toner supplies by controlling toner supply motors 165Y, 165M, 165C and 165K based on the detection result of the remaining quantities of toners obtained by the toner-remaining-quantity detection sensors 164Y, 164M, 164C and 164K.

The image forming controller 154 controls a developer, a photoreceptor, a polygon motor, and various sensors 166.

The fixing controller 155 controls the temperature and the number of rotations of a heater and a fixing motor 168.

The I/F controller 156 controls an interface controller 169.

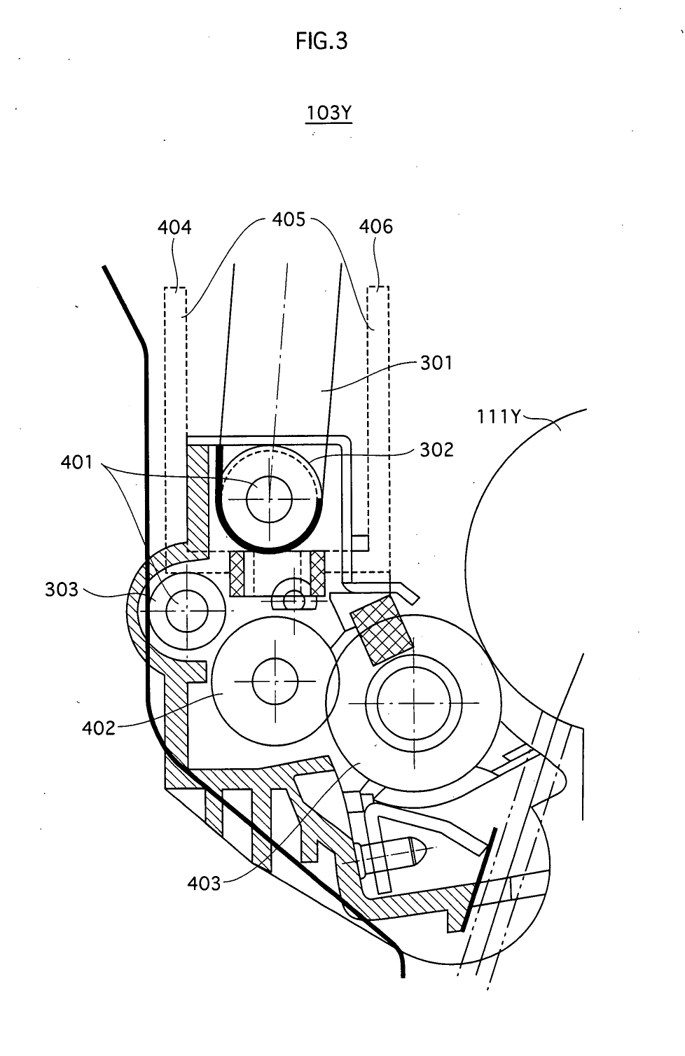

FIG. 3 is a cross sectional diagram showing a structure of the developer 103Y. Note that, since other developers 103M, 103C and 103K have the same structure, here only the developer 103Y will be explained as a representative of them.

The developer 103Y includes: a toner supplier 302; a toner agitation/transport screw 401; a buffer 303; a supply roller 402; a developing roller 403; an emitter 404 and an optical receiver 406 of the toner-remaining-quantity detection sensor; and a light guide 405.

The toner supplier 302 receives supply of toner from the toner bottle 120Y. The toner of the toner supplier 302 is pushed out to the buffer 303 due to the rotation of the toner agitation/transport screw 401. The toner in the buffer 303 is supplied to the developing roller 403 by the rotation of the supply roller 402.

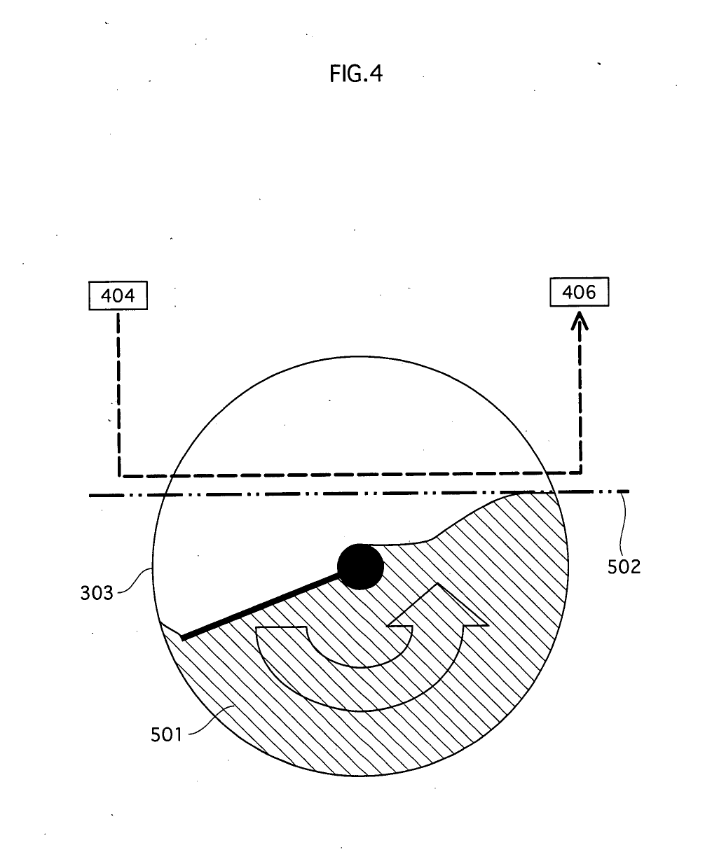

The light guide 405 guides the inspection light emitted from the emitter 404 to the optical receiver 406. As shown in FIG. 4, the guideway shown by the dotted line goes through the buffer 303.

On the other hand, an agitation blade 501 is provided in the buffer 303. As the agitation blade 501 rotates, a toner level 502 goes up and down to block the inspection light. In addition, the agitating blade 501 itself blocks the inspection light.

When the agitation blade 501 is performing agitation (i.e. when the developer 103Y is being driven to rotate), the toner level 502 in the buffer 303 is determined by monitoring the sensor output of the inspection light of the optical receiver 406.

Specifically speaking, the toner level 502 in the buffer 303 can be determined based on the length of the time during which the inspection light is blocked (the light blocking period) in one agitation cycle.

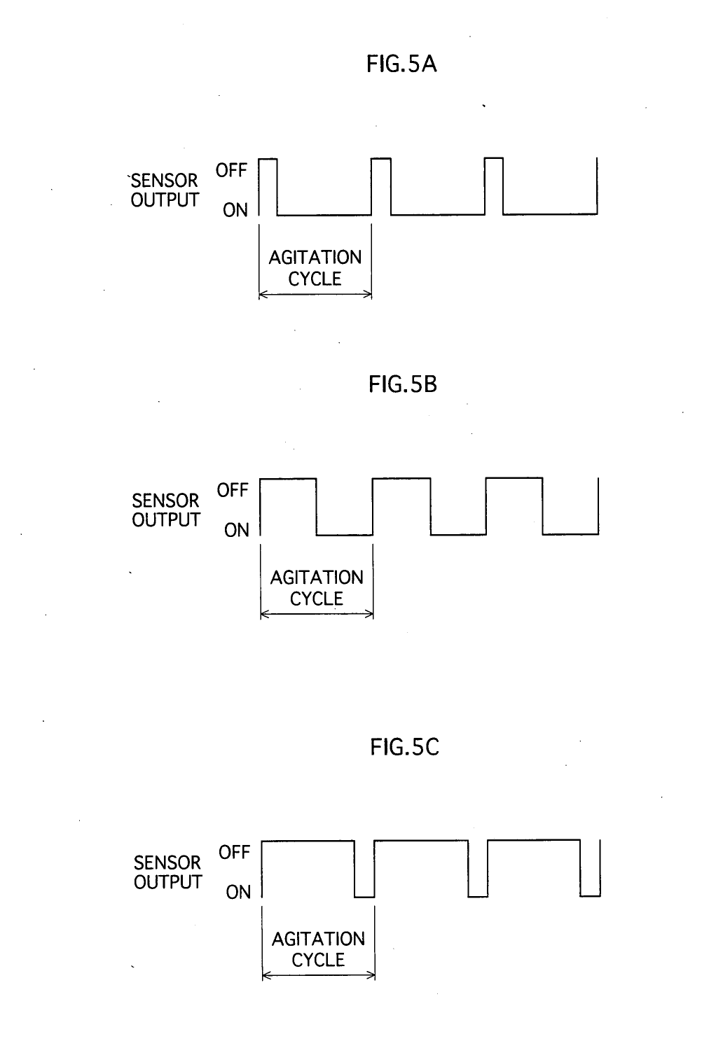

FIG. 5 is a waveform chart showing examples of the result of the sensor output of the optical receiver.

The “agitation cycle” in FIG. 5 means an agitation cycle of the agitating blade 501 of the buffer 303.

In the case when the quantity of toner remaining in the buffer 303 is low, the toner level 502 goes down. As a result, the duration of the time during the inspection light being blocked (i.e. the sensor output is off) becomes shorter.

It can be therefore determined that, when the result of the sensor output is one as shown in FIG. 5A, the quantity of toner remaining in the buffer 303 is low.

As the quantity of toner in the buffer 303 is higher, the light blocking period becomes longer. Therefore, it can be determined that a moderate quantity of toner remains in the case of FIG. 5B while a high quantity of toner remains in the case of FIG. 5C.

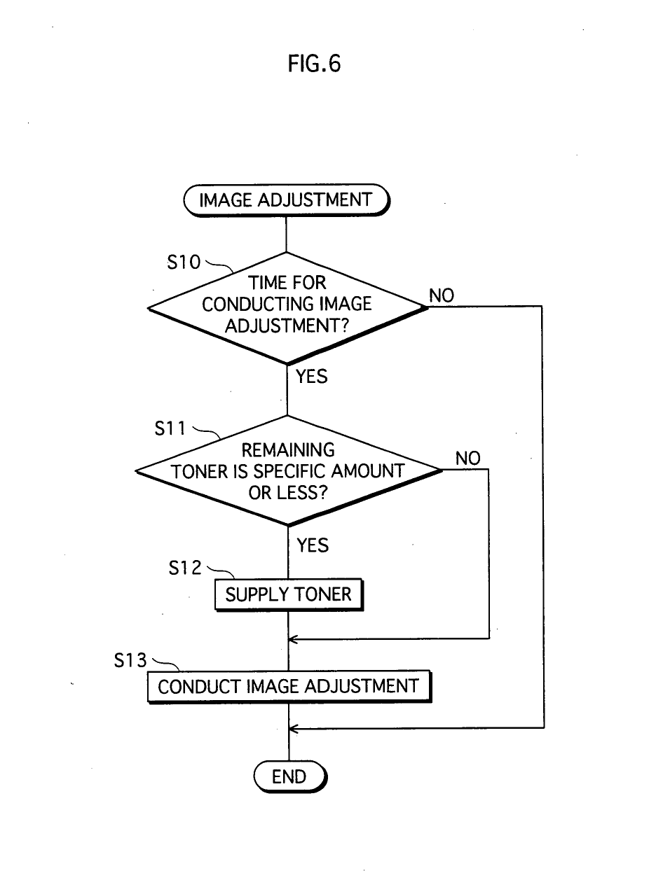

FIG. 6 is a flowchart showing an image adjustment control process carried out by the controller 140.

First, when a time for conducting image adjustment arrives (e.g. after a specific number of prints are produced, and when the power is turned on) (S10: Yes), the controller 140 does not immediately carry out image adjustment and moves to a judgment of whether toner needs to be supplied.

That is, the controller 140 judges whether the remaining toner of each color, the information of which is stored in the EEPROM 163, is a specific quantity or lower (S11). In the case when the remaining toner is the specific quantity or lower (S11: Yes), the controller 140 supplies toner of a corresponding color to the developer (S12).

Then, the controller 140 carries out an image adjustment process, such as resist correction and gamma correction (S13).

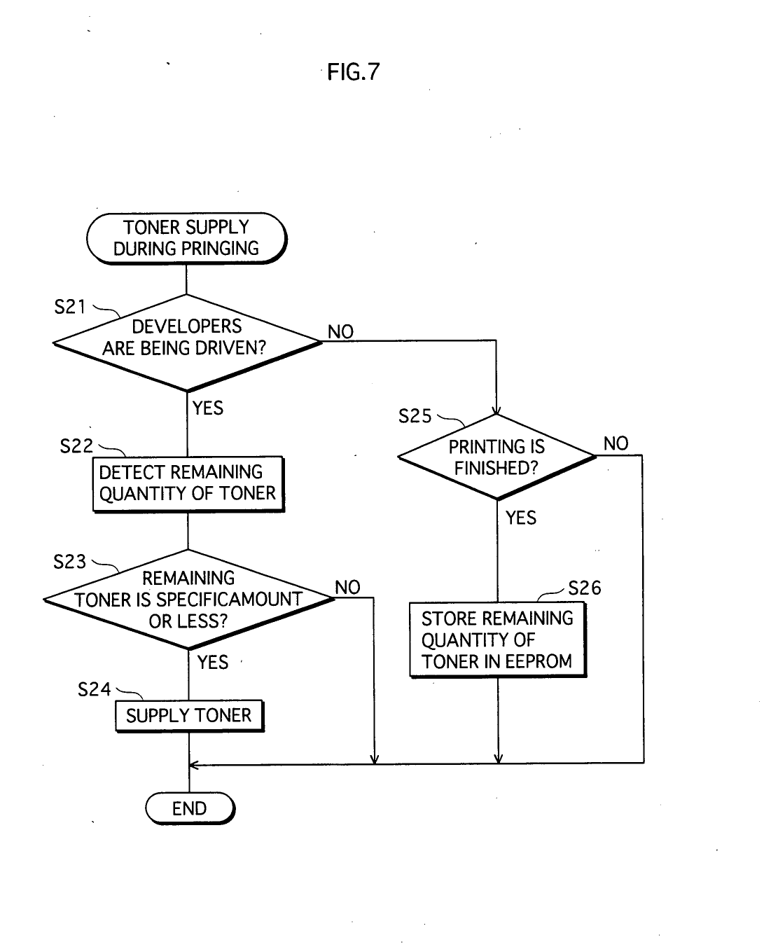

FIG. 7 is a flowchart showing a toner supply process carried out by the controller 140 during printing.

In the toner supply process during printing, if the developers 103Y, 103M, 103C and 103K are being driven (S21: Yes), the controller 140 detects the quantity of toner in each developer being driven (S22). If the detected quantity is a specific quantity or lower (S23: Yes), the controller 140 supplies toner of a corresponding color to the developer (S24). Here, the specific quantity is, for example, a moderate or lower quantity remaining in the developer.

When the developer being driven is stopped (S21: No) and the controller 140 determines that printing is finished (S25: Yes), the controller 140 stores, in the EEPROM 163, information indicating the remaining quantity of toner that has been detected by that point (S26).

When the developers are being driven—e.g. when an image adjustment process is carried out, besides when printing is being performed, the remaining quantity is detected in each case, and the information of the detected quantity is stored in the EEPROM 163.

As has been described, the need of toner supply is judged prior to the execution of an image adjustment process, and therefore the present application is able to prevent an image adjustment process from being carried out when the remaining toner quantities in the developers are insufficient

[Other Particulars]

(1) The embodiment above is explained with the case of determining the quantity of toner in the buffer based on the time during which the light is blocked. It is a matter of course, however, that the present invention is not limited to this case, and a different method can be employed to determine the quantity remaining in the buffer. For example, the remaining toner quantity may be determined from dot-counter reading corresponding to the toner quantity having been transferred to paper.

(2) It is preferable not to perform toner supply during image adjustment although the embodiment above does not give details of this. This is because, if toner is supplied during image adjustment, the toner in the developer and the newly supplied toner are not sufficiently agitated, which results in improper image adjustment.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. A color image forming apparatus comprising:
a plurality of developers;
a plurality of toner bottles, each of which contains a toner of a color corresponding to a different one of the developers;
a toner quantity detector operable to detect, with respect to each of the developers, quantity of a toner therein;
a supplier operable to perform toner supply in which the toner in one of the toner bottles is supplied to a corresponding one of the developers;
an image adjuster operable to perform an image adjustment process under a predetermined condition; and
a supply controller operable to make a judgment, with respect to each of the developers prior to the image adjustment process, on need for the toner supply based on the quantity of the toner detected by the toner quantity detector, and to cause the supplier to perform the toner supply if the judgment is affirmative.

2. The color image forming apparatus of claim 1, wherein
one of the developers is for a black toner, and
the color image forming apparatus further comprising:
a developer controller operable to drive only the developer for the black toner in a case of forming a monochrome image.

3. The color image forming apparatus of claim 1, wherein
the toner quantity detector detects the quantity of the toner only when the developer is being driven.

4. The color image forming apparatus of claim 1, further comprising:
a storage operable to store therein toner quantity information for each of the developers, the toner quantity information including the developer and the detected quantity of the toner in the developer, wherein
the supply controller makes the judgment based on the toner quantity information.
